(19) United States
(12) Patent Application Publication
(10) Pub. No.: US 2013/0036153 A1
(43) Pub. Date: Feb. 7, 2013

(54) Mobile Applications to Interface to a Brokerage System

(71) Applicant: Roy Schoenberg, Boston, MA (US)

(72) Inventor: Roy Schoenberg, Boston, MA (US)

(21) Appl. No.: 13/204,619

(22) Filed: Aug. 5, 2011

(51) Int. Cl. G06F 15/16

(52) U.S. Cl. 709/202

(57) ABSTRACT

A computer-implemented method includes receiving, by a first application running on a computing device, a request for a real-time communication with a service provider; retrieving, from a second application running on the same computing device, a geographical location of the computing device; sending, to a brokerage system, the request for the real time consultation with the geographical information; and receiving, from the brokerage system, information specifying one or more available service providers in the geographical location.

### BACKGROUND

The present invention is directed to connecting consumers with service providers.

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in U.S. Pat. No. 7,590,550, which is incorporated herein by reference.

### SUMMARY

In one aspect of the present disclosure, a computer-implemented method includes receiving, by a first application running on a computing device, a request for a real-time communication with a service provider; retrieving, from a second application running on the same computing device, a geographical location of the computing device; sending, to a brokerage system, the request for the real time consultation with the geographical information; and receiving, from the brokerage system, information specifying one or more available service providers in the geographical location.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages will be apparent from the description and drawings, and from the claims.

### BRIEF DESCRIPTION OF THE FIGURES

FIG. 1 is a diagrammatic view of an engagement brokerage service.

FIG. 2 is a flowchart of a process for interfacing through an application with a brokerage system.

FIGS. 3-4 are screen images of graphical user interfaces displayed for interfacing through the application with a brokerage system.

FIG. 5 is a block diagram of a computer (computer system) showing exemplary components that can be used for the brokerage system and/or client devices.

### DETAILED DESCRIPTION

The system described below provides applications for communication with the brokerage system described in U.S. Pat. No. 7,590,550. Through the applications, consumers of services engage in services offered through the brokerage system, including, e.g., requesting and engaging in a real-time consultation, scheduling an appointment with a service provider, collecting and view biometric information, and so forth, over mobile devices and personal digital assistants (“PDAs”), including the BlackBerry® and the Apple iPhone®. Consumers engage in these services on-line and through consumers' mobile devices.

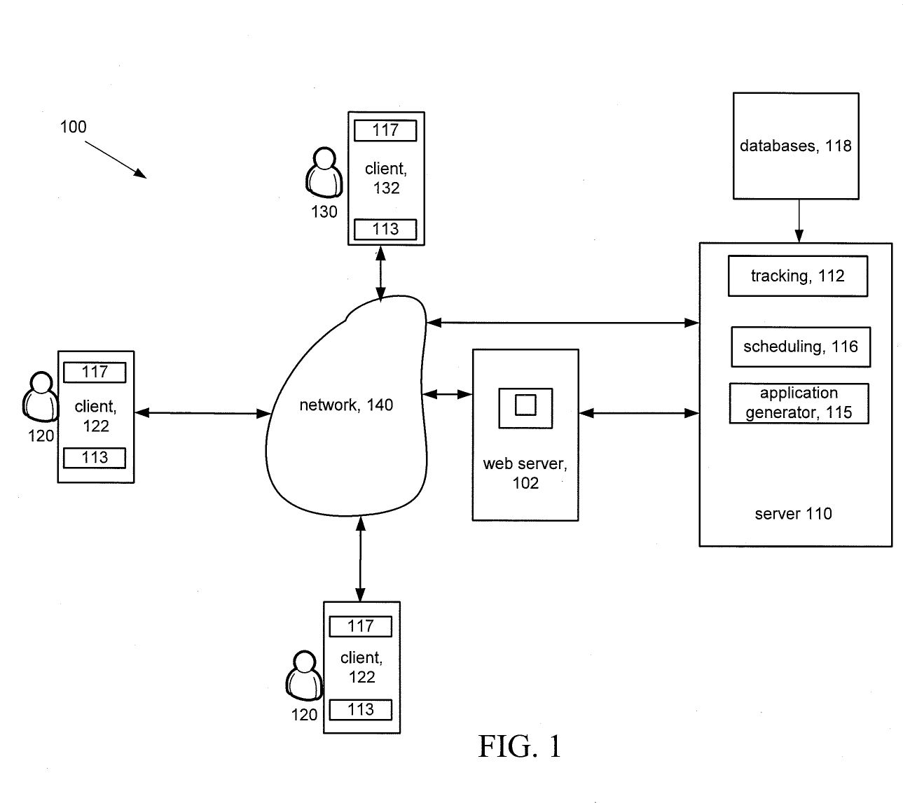

FIG. 1 shows an example system 100 implementing applications 113, 117 that integrate with brokerage system 110. Application includes a brokerage service application for interfacing with brokerage system 110. Brokerage system 110 includes a computerized system or server for making connections between consumers 120, at client devices 122, including mobile devices and PDAs, and service providers 130, at client devices 132, over a network 140, e.g., the Internet or other types of networks. Client devices 122, 132 include processing devices, mobile devices, PDAs, and other computing devices. The brokerage system 110 operates as a service running on a web server 102. The components of the system 110 and the web server 102 may be integrated or distributed in various combinations as is commonly known in the art. One implementation of brokerage system 110 is generally described in U.S. Pat. No. 7,590,550, the disclosure of which is incorporated herein by reference. The consumers 120 and service providers 130 connect with the brokerage system 110 through execution of application 113 on client devices 122, 132, as shown in FIG. 1.

Brokerage system 110 includes application generator 115 that is configured to generate application 113 (e.g., a mobile application, an online application, and so forth) for execution on client devices 122, 132. Application 113 includes a computer program configured for communication with brokerage system 110. An application includes numerous files and graphical user interfaces that are downloaded onto client devices 122, 132 and allow client devices 122, 132 to interact with brokerage system 110 and databases 118 over network 140, for example, without interfacing with web server 102.

Application 113 communicates with tracking module 112 to determine the present availability of service providers 130. Based on present availability information received from tracking module 112, application 113 renders on client device 122 a graphical user interface that displays for consumer 120 a visual representation of the present availability of service provider.

Application 113 communicates with other applications 117 running on client devices 122, 132. Applications 117 include numerous types of applications, including biometric applications, geographic position system (“GPS”) applications, scheduling applications, and so forth.

A biometric application is an application for collection of biometric information (i.e., information indicative of measurable biological characteristics of an individual, e.g., blood glucose levels, heart rate, and so forth). Application 117 collects biometric information by consumer 120 inputting biometric information into application 117. Application 117 sends the collected biometric information to brokerage system 110 for storage and/or for later retrieval.

In another example, application 117 is a GPS application that determines a geographical location of client device 122. In still another example, application 117 is a scheduling application through which consumer 120 enters scheduling information, e.g., time and date information for appointments. Application 117 synchronizes with another calendar, for example, a calendar that is part of an electronic mail application. Consumer 120 enters scheduling information into the calendar that is part of the electronic mail application. Application 117 retrieves from the electronic mail application the scheduling information.

Application 117 is an application downloaded onto client devices 122, 132 from a server external to brokerage system 110 (e.g., an external third party system). Application 113 receives information (e.g., biometric information, scheduling information, location information, and so forth) from application 117 and sends the received information to brokerage system 110. Additionally, application 113 communicates with scheduling module 116 to allow consumers 120 to schedule an appointment with a service provider, as described in further detail below. In a variation of FIG. 1, applications 113, 117 are integrated into a single application, rather than being distributed as two separate applications.

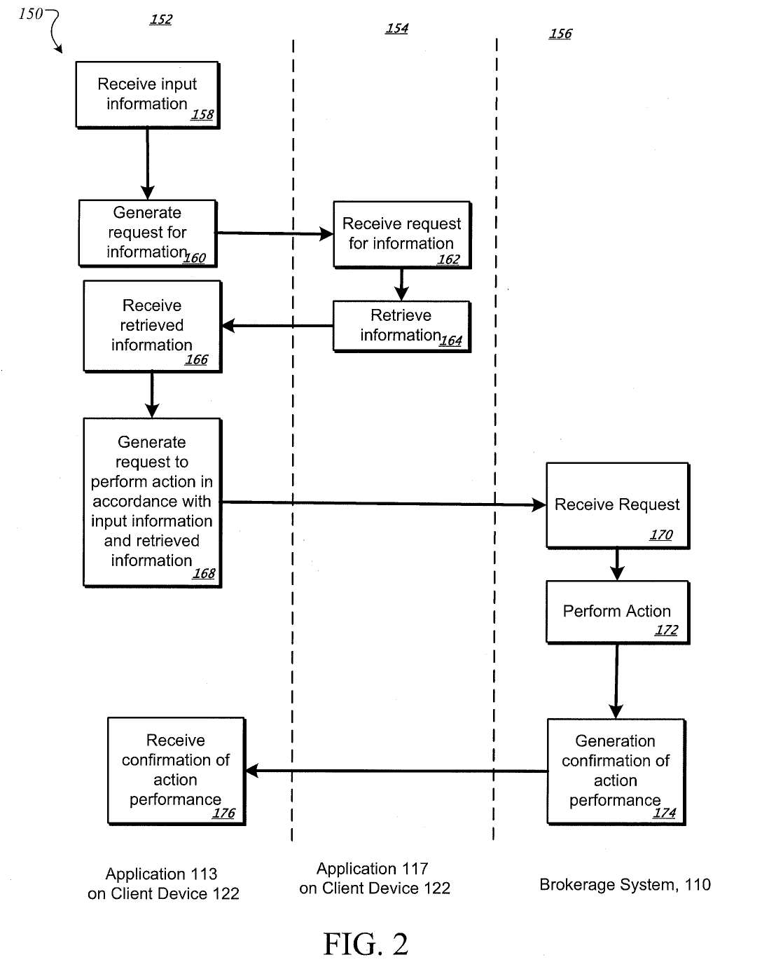

FIG. 2 shows a process 150 for interfacing through application 113 with brokerage system 110. Process 150 includes client side processes 152, 154 performed on client devices 122, 132, respectively, and a server side process 156 performed on brokerage system 110.

In operation, client device 122 receives (158) input information (not shown) from consumer 120. Input information includes a request for an appointment with a service provider, a request for a real-time consultation with a service provider, a request to view a graph of biometric information that has been collected for consumer 120 over a period of time, and so forth.

In response to the received input information, application 113 generates (160) request (not shown) for information in accordance with the received input information. For example, if the received input information is a request for an appointment with a service provider, application 113 generates a request for scheduling information for consumer 120. Application 113 sends the request to application 117, which in this example is a scheduling application.

Application 117 receives (162) the request and retrieves (164) the requested information. For example, when the requested information is scheduling information, application 117 accesses an electronic calendar for consumer 120, retrieves from the electronic calendar scheduling information for consumer 120 and sends the scheduling information to application 113.

In another example, application 113 generates a request for a geographical location of consumer 120. Application 117 is a GPS application that determines the geographical location of client device 122. Application 117 retrieves information specifying the geographical location of client device 122, for example, from an external GPS server.

Application 113 receives (166) the retrieved information from application 117. Application 113 generates (168) a request (not shown) to perform an operation by brokerage system 110 in accordance with the information input by consumer 120 and the information retrieved by application 117. In an example, the input information is a request for a real-time consultation with a service provider, and the information retrieved by application 117 is information specifying a geographical location of client device 122. Application 113 generates a request for a real-time consultation with a service provider. This request is in accordance with the received input information and the retrieved information. Application 113 sends the generated request to brokerage system 110.

Brokerage system 110 receives (170) the request. In response to receipt of the request, brokerage system 110 performs (172) the requested operation, including, e.g., determining a presently available service provider, establishing a communication channel between client device 122 and client device 132 used by service provider 130 for a real-time communication, scheduling an appointment with service provider 130, and so forth. Brokerage system 110 also generates (174) a confirmation of performance of the operation, including, e.g., a message indicating that a real-time communication channel is established, a message indicating that an appointment has been scheduled with a service provider, and so forth. Client device 122 receives (176) the confirmation and displays the confirmation in a graphical user interface on a display of client device 122.

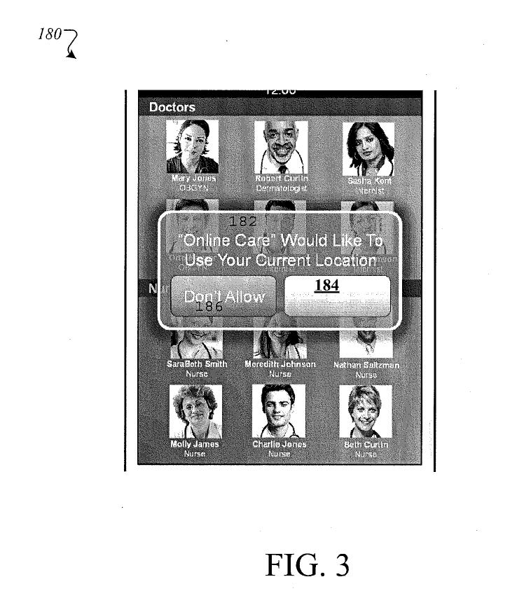

Referring now to FIG. 3, a graphical user interface 180 is generated by application 113. Graphical user interface 180 includes message 182 that prompts consumer 120 for instructions regarding use of a “current location” of client device 122. For example, consumer 120 inputs into application 113 running on client device 122 information requesting a real-time consultation with an available service provider. Application 113 sends a request to application 117 for a geographical location of client device 122. Prior to sending the request to application 117, application 113 generates message 182 prompting consumer 120 for permission to send the request to application 117.

Message 182 includes control inputs 184, 186. Following selection of control input 184, application 113 receives instructions to retrieve the geographical location of client device 122 from application 117. Following selection of control input 186, application 113 prompts consumer 120 for information indicative of the geographical location of client device 122, e.g., rather than automatically retrieving the geographical location from application 117.

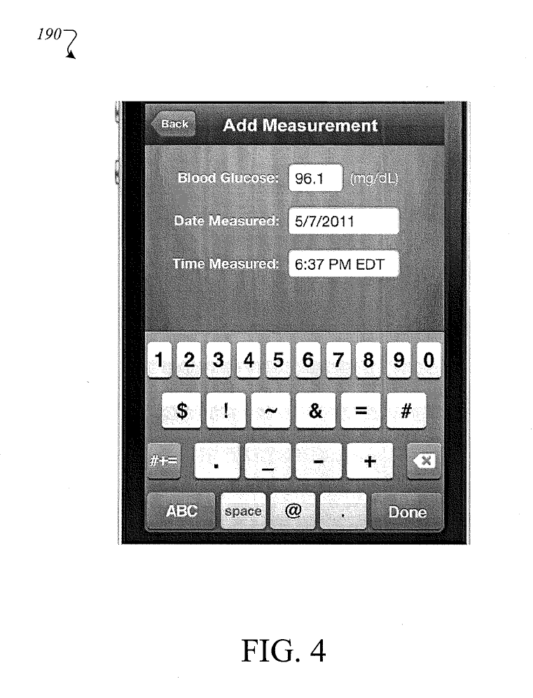

Referring now to FIG. 4, application 117 displays graphical user interface 190, through which consumer 120 inputs biometric information. Application 117 interfaces with application 113 to notify application 113 of the receipt of biometric information. In response, application 113 requests from application 117 the biometric information, receives the biometric information, and sends the biometric information to brokerage system 110. Brokerage system 110 saves the biometric information in database 118 (FIG. 1).

Brokerage system 110 receives, from application 113, biometric information over a period of time (e.g., a number of days, a number of months, a number of years, and so forth). Brokerage system 110 collects and saves the biometric information in database 118. Application 113 queries brokerage system 110 for biometric information collected on various dates and/or requests a statistical view of the biometric information, including, e.g., a display of average values for the collected biometric information, a display of mean values for the collected biometric information, a display of standard deviation values for the collected biometric information, and so forth.

In a variation of FIG. 4, graphical user interface 190 is display through application 113. Following input of biometric information to application 113, application 113 sends the biometric information to brokerage system 110.

The types of service providers included in the foregoing examples include numerous types of service providers, including, e.g., medical service providers (e.g., physicians, nurses, etc).

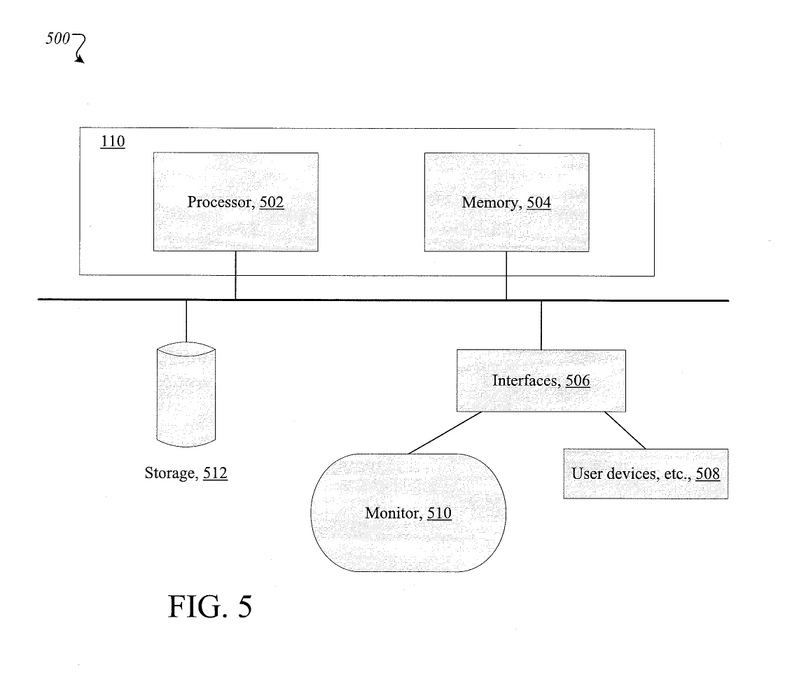

FIG. 5 depicts components 500 of the engagement brokerage system. User devices 508 can be any sort of computing device capable of taking input from a user and communicating over a network (not shown) with server 110 and/or with other client devices. For example, user device 508 can be a mobile device, a desktop computer, a laptop, a cell phone, a personal digital assistant (“PDA”), a server, an embedded computing system, a mobile device and so forth. User devices 508 include monitor 510 which render visual representations of interface 506.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device user device 508 via interfaces 506, including, e.g., graphical user interfaces. Interfaces 506 can be any type of interface capable of receiving information over a network, such as an Ethernet interface, a wireless networking interface, a fiber-optic networking interface, a modem, and so forth. Server 110 also includes a processor 502 and memory 504. A bus system (not shown), including, for example, a data bus and a motherboard, can be used to establish and to control data communication between the components of server 110.

Processor 502 may include one or more microprocessors. Generally, processor 502 may include any appropriate processor and/or logic that is capable of receiving and storing data, and of communicating over a network (not shown). Memory 504 can include a hard drive and a random access memory storage device, such as a dynamic random access memory, machine-readable media, or other types of non-transitory machine-readable storage devices.

Components 500 also include storage device 512, which is configured to store information collected through the brokerage system during a service provider's consultation with a consumer.

Embodiments can be implemented in digital electronic circuitry, or in computer hardware, firmware, software, or in combinations thereof Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

1. A computer-implemented method comprising:
receiving, by a brokerage service application running on a computing device, a request for a real-time communication with a service provider;
sending a message by the brokerage system application for prompting a user of the computing device for permission to send a request to a global positioning application running on the computing device;
determining a current geographic location of the computing device by the global positioning application, when permission is received by the global positioning application, with the global positioning application on the computing device being in communication with a global positioning server system, and with the brokerage service application being in communication with the global positioning application;
sending, to a brokerage system by the brokerage service application, the request for the real-time communication with the current geographic location of the computing device; and
receiving, from the brokerage system, information specifying one or more available service providers in the current geographic location.

2. The computer-implemented method of claim 1, wherein the request further comprises one or more of:
a request for an appointment with the service provider, and a request to save biometric information.

3. The computer-implemented method of claim 1, wherein the global positioning application comprises:
an application configured to provide global positioning system (“GPS”) services.

4. The computer-implemented method of claim 1, wherein the brokerage service application is for interfacing with the brokerage system.

5. The computer-implemented method of claim 1, further comprising:
downloading, from the brokerage system onto the computing device, the brokerage service application.

6. The computer-implemented method of claim 1, further comprising:
sending, by the brokerage service application to the global positioning application running on the same computing device, a request for the current geographic location of the computing device.

7. A computer-implemented method comprising:
receiving, from an application running on a computing device, a request for a real-time communication with a service provider, with the request comprising information specifying a geographical location of the computing device;
determining, by one or more computing devices based on the geographical location, one or more available service providers in the geographical location; and
establishing, by the one or more computing devices through the application running on the computing device, a real-time communication channel for communication between a consumer and one of the one or more available service providers.

8. A computer program product embedded in a computer readable medium, the computer program product comprising instructions for causing a computing device to:
receive, by a brokerage service application running on the computing device, a request for a real-time communication with a service provider;
send a message by the brokerage system application for prompting a user of the computing device for permission to send a request to a global positioning application running on the computing device;
determine a current geographic location of the computing device by the global positioning application, when permission is received by the global positioning application with the global positioning application on the computing device being in communication with a global positioning server system, and with the brokerage service application being in communication with the global positioning application;
send, to a brokerage system by the brokerage service application, the request for the real-time communication with the current geographic location of the computing device; and
receive, from the brokerage system, information specifying one or more available service providers in the current geographic location.

9. The computer program product of claim 8, wherein the request further comprises one or more of:
a request for an appointment with the service provider, and a request to save biometric information.

10. The computer program product of claim 8, wherein the global positioning application comprises:
an application configured to provide global positioning system (“GPS”) services.

11. The computer program product of claim 8, wherein the brokerage service application is for interfacing with the brokerage system.

12. The computer program product of claim 8, wherein the instructions further comprise instructions for causing the computing device to:
download, from the brokerage system onto the computing device, the brokerage service application.

13. The computer program product of claim 8, wherein the instructions further comprise instructions for causing the computing device to:
send, by the brokerage service application to the global positioning application running on the same computing device, a request for the current geographic location of the computing device.

14. An apparatus comprising:
a processor; and
a computer program product embedded in a computer readable medium, the computer program product comprising instructions for causing the processor to:
receive, by a brokerage service application running on the processor, a request for a real-time communication with a service provider;
send a message by the brokerage system application for prompting a user of the processor for permission to send a request to a global positioning application running on the processor;
determine a current geographic location of the processor by the global positioning application, when permission is received by the global positioning application, with the global positioning application on the processor being in communication with a global positioning server system, and with the brokerage service application being in communication with the global positioning application;
send, to a brokerage system by the brokerage service application, the request for the real-time communication with the current geographic location of the processor; and
receive, from the brokerage system, information specifying one or more available service providers in the current geographic location.

15. The apparatus of claim 14, wherein the request further comprises one or more of:
a request for an appointment with the service provider, and a request to save biometric information.

16. The apparatus of claim 14, wherein the global positioning application comprises:
an application configured to provide global positioning system (“GPS”) services.

17. The apparatus of claim 14, wherein the brokerage service application is for interfacing with the brokerage system.

18. The apparatus of claim 14, wherein the instructions further comprise instructions for causing the processor to:
download, from the brokerage system onto the processor, the brokerage service application.

19. The apparatus of claim 14, wherein the instructions further comprise instructions for causing the processor to:
send, by the brokerage service application to the global positioning application running on the same computing device, a request for the current geographic location of the computing device.
